(19) United States
(12) Patent Application Publication
(10) Pub. No.: US 2010/0214414 A1
(43) Pub. Date: Aug. 26, 2010

(54) HMD APPARATUS FOR USER WITH RESTRICTED FIELD OF VISION

(75) Inventor: Bernd Spruck, Moegglingen (DE)

Correspondence Address: PATTERSON THUENTE CHRISTENSEN PEDERSEN, P.A., 4800 IDS CENTER, 80 SOUTH 8TH STREET, MINNEAPOLIS, MN, 55402-2100, US

(73) Assignee: CARL ZEISS AG, Oberkochen (DE)

(21) Appl. No.: 12/446,092

(22) PCT Filed: Oct. 11, 2007
(86) PCT No.: PCT/EP2007/008851

§ 371 Date: Apr. 17, 2009

(30) Foreign Application Priority Data
Oct. 19, 2006 (DE) 10 2006 049 404.0

(51) Int. Cl. H04N 7/18

(52) U.S. Cl. 348/158; 348/E07.091

(57) ABSTRACT

An HMD apparatus including a head mount to be mounted on the head of a user, a camera having a predetermined field of view, and a display module, both mounted to the head mount. When the head mount is mounted on the head, the predetermined field of view is greater than a visual field of a first eye of the user, and the camera records an image of the surroundings located in the field of view in the viewing direction of the first eye. The camera transmits the image to the display module which presents the image to the first eye of the user such that the image is located completely within the user's visual field.

### PRIORITY CLAIM

The present application is a National Phase entry of PCT Application No. PCT/EP2007/008851, filed Oct. 11, 2007, which claims priority from German Application Number 102006049404.0, filed Oct. 19, 2006, the disclosures of which are hereby incorporated by reference herein in their entirety.

### FIELD OF THE INVENTION

The present invention relates to an HMD apparatus (Head Mounted Display apparatus), which is suitable, in particular, for users with a limited visual field.

### BACKGROUND

Such limitations of the visual field appear in connection with certain diseases of the eye or of the respective nervous system. When such a limitation of the visual field is permanent and cannot be treated by medication, it is attempted nowadays to achieve a certain compensation of the limited visual field by purposeful training of the eye movement. However, for the affected individual, this training is accompanied by great inconvenience and a considerable change of the visual process.

Further, it is attempted to produce an improvement by using prismatic spectacles. However, this only leads to an offset of the perceived image, so that no additional visual information is gained for the affected individual. Therefore, the affected individual can perceive the surroundings only within an angular range that is greatly restricted for said individual.

### SUMMARY

In view thereof, it is an object of the invention to provide an HMD apparatus allowing to compensate for a limitation of the visual field.

According to the invention, this object is achieved by an HMD apparatus, comprising a head mount to be mounted on the head of a user, a camera having a predetermined field of view, and a display module, both mounted to the head mount, wherein, when the head mount is mounted on the head, the predetermined field of view is greater than a visual field of a first eye of the user, and the camera records an image of the surroundings located in the field of view in the viewing direction of the first eye and transmits said image to the display module which presents the image to the first eye of the user such that the image is located completely within the user's visual field.

Since the predetermined field of view is greater than the visual field of the user's first eye, a region of the surroundings is recorded that is greater than that which the user could perceive without the HMD apparatus. This greater region is then presented to the user via the display module, in a manner adapted to the user's visual field, allowing him to optically perceive information from a greater region of the surroundings despite his limited visual field.

As used herein, the visual field means that region which the user can perceive with one eye, without an HMD apparatus and without any eye movement. The field of view of the camera is that region of the surroundings which the camera can record.

In particular, the display module may have a field of view in which the image is presented and which is smaller than the field of view of the camera. Thus, it is very simply possible to carry out a desired transformation of the visual angle and to optically provide to the user the information of the image of the surroundings located within the field of view of the camera.

The display module may comprise an image-generating element with a multiplicity of pixels and an image unit which maps the image points of the recorded image to the pixels according to a predetermined transformation rule. This allows the achievement of even greater flexibility and to adapt the HMD apparatus individually to the respective limitation of the visual field.

If the limitation of the visual field consists, for example, in that a certain region within the visual field is no longer visually perceivable by the user, the transformation can be defined such that image information corresponding to this region is transformed into regions which the user can still perceive. In this case, the display module can display the (entire) image in the visual field surrounding said region. Even if there is a gap in the visual field (for example, the visual field may have an annular or circular shape), the entire image can be presented to the user such that he can perceive it.

The extent and geometry of the region affected by the gap in the visual field of the user can be very precisely determined and measured nowadays, for example using a perimeter. These data can then be used to define a suitable transformation rule.

In particular, the HMD apparatus is provided such that the user perceives the surroundings only via the HMD apparatus and, thus, via the image provided by the display module. Such an apparatus is also called a video see-through apparatus.

The transformation rule may cause, in particular, a non-linear and/or a non-monotonic mapping. Thus, mappings are possible which could not be realized optically or only in a very complex manner.

Thus, for example, great shifts in the display of the image by means of the display module or gaps in the display of the image can be realized. It is also possible to divide the field of view of the camera up into subsections that are each transformed differently.

Further, the electronic mapping by means of the transformation rule achieves the advantage that the HMD apparatus can be mass-produced, for example, and each individual HMD apparatus can be optimally adapted to the respective user by suitably defining the transformation rule. Thus, it is only required to select the transformation rule accordingly. Further, it is also possible to adapt the transformation rule to further changes in the limitation of the visual field of an individual user, which may occur in the course of time.

In particular, the HMD apparatus comprises two cameras, which respectively record one image for the left eye and one image for the right eye, each image being separately presented to the left and to the right eye, respectively, via the display module. In this case, it is also possible to present the recorded images to the user stereoscopically.

The display module presents the image(s), in particular, as a virtual image(s). The display module may be provided as in conventional HMD apparatuses. In particular, it may comprise an image generating element and imaging optics. The image generating element may be a self-luminous or non-self-luminous element comprising a multiplicity of pixels that can be controlled independently of each other. Further, a control unit is preferably provided to which the recorded image of the camera(s) is supplied and which then controls the image generating element accordingly. In particular, the display module may comprise a display unit for each eye, substantially identical in design.

Further, the HMD apparatus may also comprise detection optics which are preferably mounted to the head mount and detect the user's eye movement. Depending on the eye movement, the field of view of the camera is then oriented according to the determined viewing direction. This may be effected electronically or even mechanically by rotation of the camera.

Further, a display method for a user is provided, wherein an image of the surroundings located in a predetermined field of view is recorded in the viewing direction of a first eye of the user, said predetermined field of view being greater than a visual field of the user's first eye, and wherein the image is presented to the user's first eye such that the image is located completely within the user's visual field. This enables a user with a limited visual field to optically perceive information from regions that he could not perceive without this method, due to his limited visual field.

It is possible, in particular, if the user's visual field encloses a region in which he cannot perceive any image information, to present to the user the (entire) image only in the visual field surrounding said region.

In the method, the image may be presented in a display field of view that is smaller than the predetermined field of view. This makes it particularly easy to carry out the desired transformation of the visual angle.

It is further possible to use an image generating element with a multiplicity of pixels to present the image, the image points of the recorded image being mapped to the pixels according to a predetermined transformation rule. This step allows optimal adaptation of the display method to the respective limitation of the visual field.

The performed mapping may be, in particular, a non-linear and/or non-monotonic mapping. Such a mapping cannot be realized by purely optical means or only in an extremely complex manner.

Further, an image can be recorded for each eye of the user and said image is then presented to the corresponding eye. The image(s) is (are) preferably presented as a virtual image(s).

It will be appreciated that the aforementioned features and those yet to be explained below can be used not only in the indicated combinations, but also in other combinations, or alone, without departing from the scope of the present invention.

### BRIEF DESCRIPTION OF THE DRAWINGS

The invention will be explained in more detail below, by way of example and with reference to the attached drawings, which also disclose features essential to the invention and wherein:

FIG. 1 shows a schematic top view of a first embodiment of the HMD apparatus according to the invention;

FIG. 2 is a schematic view explaining the normal visual field;

FIG. 3 is a schematic view explaining the limited visual field;

FIG. 4 is a schematic view explaining the transformation of the visual angle carried out by means of the HMD apparatus of FIG. 1;

FIG. 5 is a schematic view describing another limitation of the visual field;

FIG. 6 is a schematic view of a normal visual field;

FIG. 7 is a schematic view explaining the transformation carried out during image generation;

FIG. 8 is a schematic view explaining a possible transformation for image generation;

FIG. 9 is a schematic view of a normal visual field;

FIG. 10 is a schematic view representing the transformation carried out during image generation;

FIG. 11 is a schematic view of a normal visual field, and

FIG. 12 is a schematic view explaining the transformation carried out during image generation.

### DETAILED DESCRIPTION

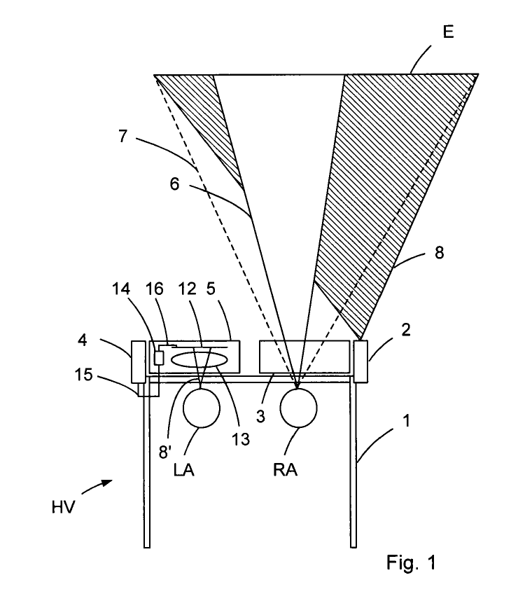

In the embodiment of the HMD apparatus HV according to the invention, shown in FIG. 1, said apparatus comprises a head mount 1 to be mounted on the head (not shown) of a user, said head mount being provided in the form of a spectacle frame. The user is indicated merely by schematic drawings of both eyes LA, RA as circles in FIG. 1.

A first camera 2 as well as a first display unit 3 for the right eye RA of the user are mounted to the head mount 1. In the same manner, a second camera 4 as well as a second display unit 5 for the left eye LA of the user are mounted to the head mount 1. Since both cameras 2 and 4 as well as both display units 3 and 5 are substantially identical in design and operation, the function of the I-IMD apparatus will be described below mainly with reference to the user's right eye RA.

The HMD apparatus HV is provided such that the cameras 2, 4 record the surroundings in the user's viewing direction and display these surroundings for him via the display units 3, 5. Thus, the user no longer sees his surroundings directly but only by means of the display units 3, 5. Such an HMD apparatus is often referred to as a video see-through apparatus.

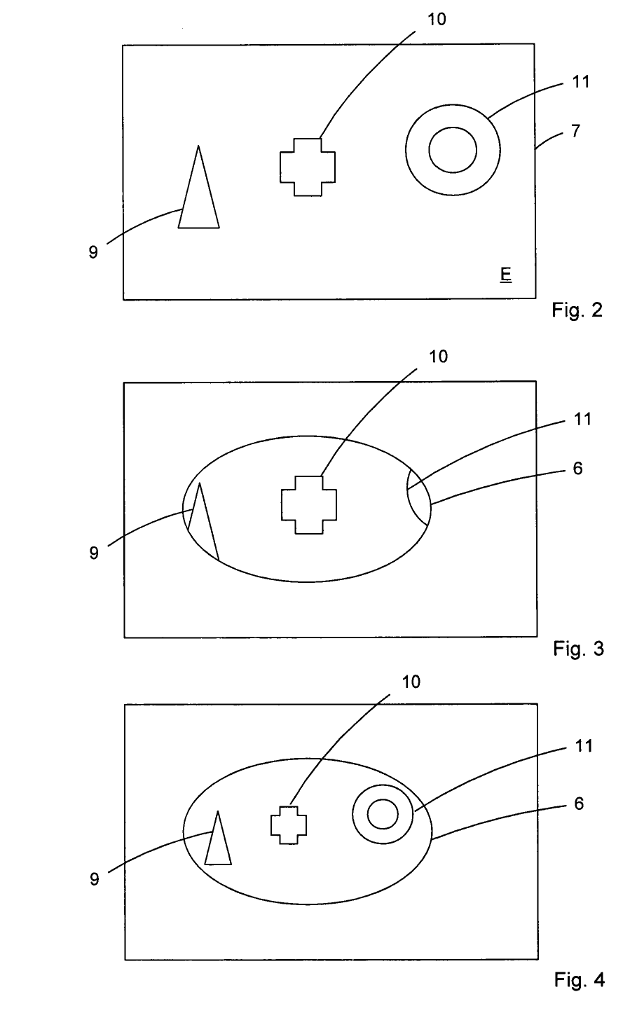

As schematically shown in FIG. 2, three objects 9, 10 and 11 are located in a plane E, in front of the user, in the normal visual field 7. The user's visual field 6 is assumed to be limited due to a disease of the right eye RA. However, due to the user's limited visual field 6, as illustrated in FIG. 3, the user only sees the object 10 in the middle (cross) completely. The user sees only part of the left and right objects 9, 11 (triangle and circular ring).

The first camera 2 records the entire normal visual field 7 that a healthy user would perceive with his right eye RA, including all three objects 9-11, because the field of view 8 of the first camera 2 is adapted to coincide with the normal visual field 7 in the plane E. The recorded image is transmitted from the first camera 2 to the first display unit 3, which presents the recorded image to the user such that all image information of the normal visual field 7 is projected into the limited visual field 6 still just perceivable by the user. Thus, a transformation of the visual angle is effected for the user so that he can perceive all objects 9-11 again, as schematically shown in FIG. 4.

In the present embodiment, this transformation of the visual angle is achieved by the field of view 8 of the first camera being greater than the visual field in which the first display unit 3 represents the recorded image. For the second display unit 5, the field of view 8′ during image projection is schematically represented.

Thus, for example, the camera may have an angle of aperture of 80°, and the first display unit 3 may project the image at an angle of aperture of 40°. This doubles the real visual angle which the user can perceive. For example, if the user's limited visual field 6 has an angle of aperture of 40° in a first direction, the user can perceive the surroundings with a visual field angle of 80°, using the HMD apparatus of FIG. 1, via the representation on the first display unit 3. Even in case of a limited visual field 6 with an angle of aperture of 20°, the user would be able to perceive the surroundings at a visual field angle of 40°. This doubles the surrounding area which the user can perceive. Thus, the HMD apparatus HV transforms regions that were previously not visible for the user into an angular range in which the user can perceive an image.

The first display unit 3 and the second display unit 5 are identical in design. It is schematically shown for the second display unit 5 that the display units 3, 5 each comprise an image-generating element 12, imaging optics 13 as well as a control unit 14. The image data of the camera 2,4 are supplied via a line 15 to the control unit 14, which controls the image-generating element 12 via a connection 16 such that the recorded image is displayed. The recorded image is then presented to the user as a virtual image by means of the imaging optics 13. In this case, a self-luminous element—an OLED module which comprises a multiplicity of independently controllable pixels (not shown) for image generation—is used as the image-generating element.

In the described embodiment, the extension of the perceivable visual field for the user is achieved by the different visual fields and by the cameras 2, 4 and display units 3, 5.

In a further embodiment, it is possible to provide the control unit 14 such that it performs a predetermined mapping between the image points of the recorded image and the pixels of the image-generating element 12. This allows, in particular, transformations which are not possible by optical means. Moreover, optimal adaptation of the HMD apparatus to the respective user is possible. Thus, it is only required to measure the precise impairment of the user's visual field (for example, using a perimeter). These data then allow determining the transformation which the control unit 14 needs to carry out.

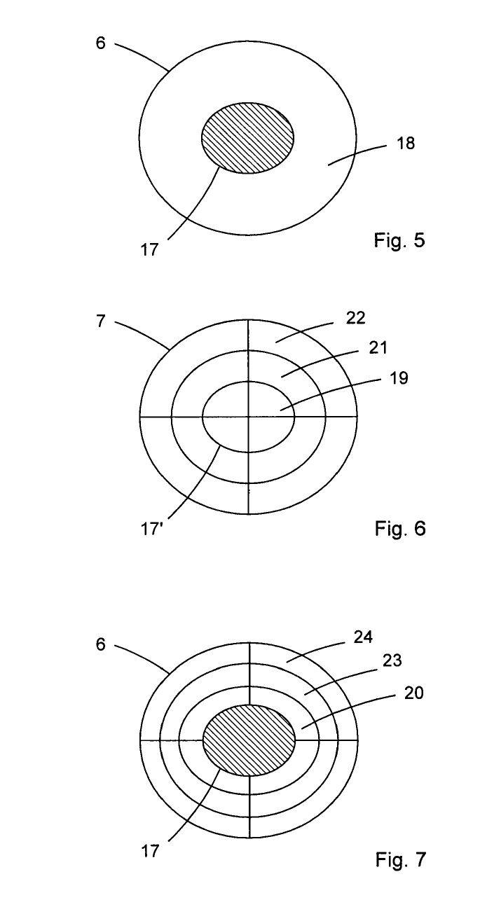

FIG. 5 schematically shows a limited visual field 6 of a user, who cannot perceive image information in a central region 17 of the visual field 6 due to a disease.

In this case, the transformation to be carried out by the control unit 14 is defined such that the image information of the central region 17′ (FIG. 6) in the recorded image, which the user would not be able to perceive due to his limited visual field 6, is displayed to the user in a circular ring around the central region 17 (FIG. 7). In other words, the entire image information of the normal visual field 7 is displayed to the user in the circular ring-shaped visual field region 18 (FIG. 5), which the user can still perceive.

This is schematically illustrated in FIGS. 6 and 7 by the depicted subdivisions, which are not visible, of course, and only serve the purpose of explanation. Thus, the circular segment 19 of the central region 17′ is transformed into the circular ring segment 20. Accordingly, the circular ring segments 21 and 22 are transformed into the circular ring segments 23 and 24. Although this leads to distortion of the image, it has turned out that a user wearing the HMD apparatus HV adapts to this distortion after a certain time and perceives the presented image without distortion.

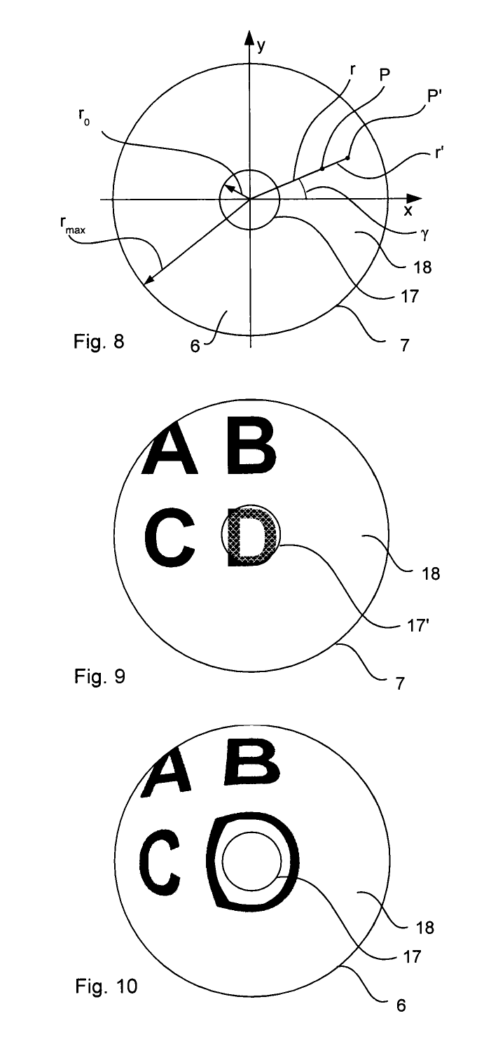

In the following, a special transformation will be described as an example with reference to FIG. 8, by which transformation it is possible to display to the user the entire image information of the normal visual field 7 in the circular ring-shaped visual field region 18 that is still perceivable for the user. For easier description, it is therefore assumed that the normal visual field 7 is circular and has a maximum diameter rₘₐₓ. The user can perceive no image information in a circular region 17 having a diameter of r₀. The limited visual field 6 of the user, thus, has a circular ring shape with an outer diameter of rₘₐₓ and an inner diameter of r₀.

For easier description, it is further assumed that the centers of the normal visual field 7 and of the central region 17 coincide, so that the desired transformation can be achieved by compressing the image in a radial direction. Thus, each point P of the recorded image is transformed into a point P′ located within the circular ring 18. The radius r′ of the point P′ is calculated from the radius r of the point P according to the following formula 1

$${r}^{′} = \frac{{r}_{max} - {r}_{0}}{{r}_{max}} \cdot r + {r}_{0} \qquad ( 1 )$$

The fraction

$$\frac{{r}_{max} - {r}_{0}}{{r}_{max}}$$

may be referred to as the compression factor of transformation. If the point P(x,y) is represented in Cartesian coordinates, it is transformed to the point P′(x′,y′), for which purpose the following formulae 2-5 can be used

$$\begin{matrix}r = \sqrt{{x}^{2} + {y}^{2}} & ( 2 ) \\ γ = arc cos \frac{x}{r} for y \geq 0 & ( 3 a ) \\ γ = - arc cos \frac{x}{r} for y < 0 & ( 3 b ) \\ {x}^{′} = {r}^{′} \cdot cos γ & ( 4 ) \\ {y}^{′} = {r}^{′} \cdot sin γ & ( 5 )\end{matrix}$$

An example of this transformation is shown in FIGS. 9 and 10. FIG. 9 shows the image to be covered, represented by the four letters A, B, C and D, the greatest part of the letter D lying in the region 17′, so that a user who can only perceive the circular ring 18 would not see the letter D. The region 17′ is schematically depicted in FIG. 9 for clarification.

FIG. 10 shows the image presented to the user. Due to the transformation, the letter D is now located completely within the ring-shaped region 18.

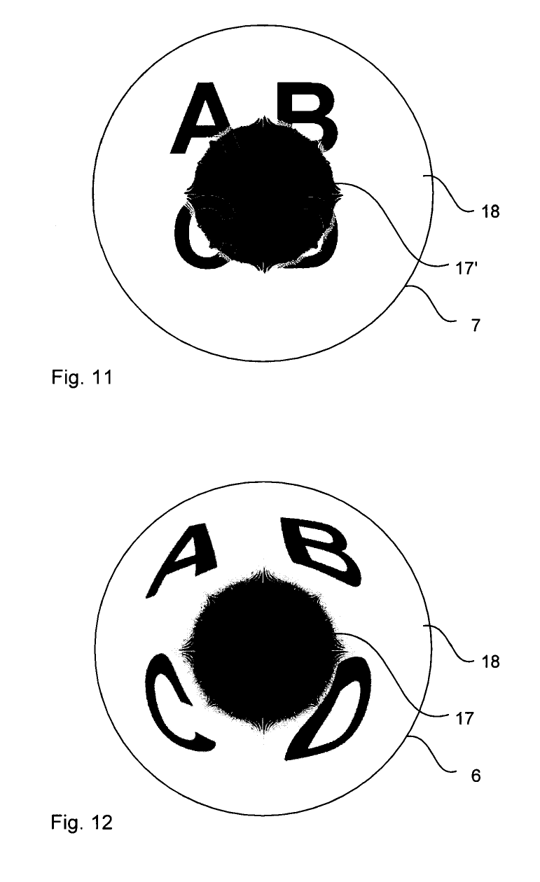

FIGS. 11 and 12 show another example. In this case, part of each letter A-D is located within the region 17′ (FIG. 11; the region 17′ is schematically shown for clarification). After the transformation, the image shown in FIG. 12 is presented to the user, in which image all letters A-D are located completely within the circular ring-shaped region 18 and can, thus, be perceived by the user.

The value of the radius r₀ is selected according to the severity of the disease (i.e. the size of the region 17). In particular, the value of the radius r₀ may be from 0.2 rₘₐₓ to 0.6 rₘₐₓ or from 0.2 rₘₐₓ to 0.4 rₘₐₓ.

The HMD apparatus shown in FIG. 1 is adapted for stereoscopic perception. Due to the great lateral distance of both cameras 2, 4, the advantage is achieved that, when wide angle lenses are used, the respectively greater stereo base is provided to enable the same depth perception as in the natural observation of the surroundings.

1-16. (canceled)

17. An HMD apparatus, comprising
a head mount to be worn on the head of a user,
a first camera having a predetermined field of view, and a display module, both mounted to the head mount,
wherein, when the head mount is worn on the head, the predetermined field of view is greater than a visual field of a first eye of the user, and the camera records an image of the surroundings located in the field of view in the viewing direction of the first eye and transmits the image to the display module which presents the image to the first eye of the user such that the image is located completely within the user's visual field.

18. The apparatus as claimed in claim 17, wherein the visual field encompasses a region, in which the user cannot perceive any image information, and the display module displays the image in the visual field surrounding the region.

19. The apparatus as claimed in claim 17, wherein the display module has a field of view in which the image is presented and which is smaller than the field of view of the camera.

20. The apparatus as claimed in claim 17, wherein the display module comprises an image-generating element with a multiplicity of pixels and an image unit that maps the image points of the recorded image to the pixels according to a predetermined transformation rule.

21. The apparatus as claimed in claim 18, wherein the display module comprises an image-generating element with a multiplicity of pixels and an image unit that maps the image points of the recorded image to the pixels according to a predetermined transformation rule.

22. The apparatus as claimed in claim 20, wherein the transformation rule results in a non-linear mapping.

23. The apparatus as claimed in claim 21, wherein the transformation rule results in a non-linear mapping.

24. The apparatus as claimed in claim 20, wherein the transformation rule results in a non-monotonic mapping.

25. The apparatus as claimed in claim 21, wherein the transformation rule results in a non-monotonic mapping.

26. The apparatus as claimed in claim 17, further comprising a second camera mounted to the head mount, such that the first camera is provided for the first eye and the second camera is provided for the second eye and each camera captures an image that is presented to the corresponding eye by the display module.

27. The apparatus as claimed in claim 17, wherein the display module presents the image as a virtual image.

28. The apparatus as claimed in claim 17, wherein the visual field encompasses a region, in which the user cannot perceive any image information, and the display module displays the image in the visual field such that all of the image is relocated into the portion of the visual field that excludes the region.

29. A display method for a user, comprising:
digitally recording an image of surroundings located in a predetermined field of view via a camera directed in the viewing direction of a first eye of the user;
defining the predetermined field of view of the camera such that it is greater than a visual field of the first eye of the user; and
presenting the image to the first eye of the user such that the image is located completely within the visual field of the first eye of the user.

30. The method as claimed in claim 29, wherein the visual field includes a region in which the user cannot perceive any image information; and
further comprising presenting the image in the visual field surrounding the region in which the user cannot perceive any image information.

31. The method as claimed in claim 29, wherein presenting further comprises presenting the image in a display field of view that is smaller than the predetermined field of view.

32. The method as claimed in claim 29, wherein presenting further comprises presenting the image via an image-generating element with a multiplicity of pixels; and
mapping the image points of the recorded image to the pixels according to a defined transformation rule.

33. The method as claimed in claim 30, wherein presenting further comprises presenting the image via an image-generating element with a multiplicity of pixels; and
mapping the image points of the recorded image to the pixels according to a defined transformation rule.

34. The method as claimed in claim 32, further comprising performing a non-linear mapping on the basis of the transformation rule.

35. The method as claimed in claim 33, further comprising performing a non-linear mapping on the basis of the transformation rule.

36. The method as claimed in claim 32, further comprising performing a non-monotonic mapping on the basis of the transformation rule.

37. The method as claimed in claim 33, further comprising performing a non-monotonic mapping on the basis of the transformation rule.

38. The method as claimed in claim 29, further comprising recording an image for each eye of the user; and
presenting the recorded image to the corresponding eye.

39. The method as claimed in claim 29, further comprising presenting the image as a virtual image.

40. The method as claimed in claim 29, wherein the visual field encompasses a region, in which the user cannot perceive any image information, and further comprising displaying the image in the visual field such that all of the image is relocated into the portion of the visual field that excludes the region.
